(19) United States
(12) Patent Application Publication
(10) Pub. No.: US 2026/0184950 A1
(43) Pub. Date: Jul. 2, 2026

(54) A 2K CLEARCOAT COATING COMPOSITION AND ITS APPLICATION THEREOF

(71) Applicant: BASF COATINGS GMBH, Muenster (DE)

(72) Inventors: Yang ZHANG, Shanghai (CN); Lei HE, Shanghai (CN); Xiao Gang YOU, Shanghai (CN)

(21) Appl. No.: 19/131,807

(22) PCT Filed: Nov. 22, 2023
(86) PCT No.: PCT/EP2023/082729

§ 371 Date: May 21, 2025

(30) Foreign Application Priority Data
Dec. 15, 2022 (WO) PCT/CN22/139323

(51) Int. Cl. C09D 133/06; C08G 18/32; C08G 18/62; C08G 18/79; C09D 125/14

(52) U.S. Cl. CPC C09D 133/066; C09D 125/14; C08G 18/3256; C08G 18/6229; C08G 18/792

(57) ABSTRACT

Disclosed herein is a 2K clearcoat coating composition including Component I including (A) a first resin having at least one primary hydroxyl group selected from the group consisting of hydroxyl alkyl (meth)acrylate resins having C₁-C₁₀, (B) a second resin having at least one secondary hydroxyl group selected from the group consisting of hydroxyl alkyl (meth)acrylate resins having C₂-C₁₀, and (C) at least one amino resin, and Component II including (D) a crosslinker including at least one polyisocyanate, where the first resin has a hydroxyl value in a range of from 100 to 250 mgKOH/g and a weight average molecular weight in a range of from 3,000 to 15,000, and the second resin has a hydroxyl value in a range of from 150 to 500 mgKOH/g and a weight average molecular weight in a range of from 500 to 2,500. Also disclosed herein is an article coated by the coating composition.

### TECHNICAL FIELD

The present invention relates to a 2K clearcoat coating composition used for automotives.

### BACKGROUND

Clearcoat provides both decoration and protection for automotives as topcoat and therefore it needs to have high initial gloss, good appearance and sufficient hardness at the same time. To reach such performance requirements, clearcoat must be highly crosslinked by baking process. Currently, solvent-borne 2K clearcoat generally needs to be baked at a temperature above 140° C. for at least 30 min to ensure sufficient crosslinking. Since the reduction of carbon emission is becoming a trend in society and the reduction of baking temperature can bring great savings on energy, it is necessary to reduce the baking temperature as much as possible.

Moreover, for environmental protection purpose, a coating composition to form clearcoat is asked to have low VOC i.e. high solid content. However, low VOC or high solid content brings high viscosity to the coating composition and it is difficult to apply a coating composition having high viscosity to obtain good appearance, not to mention those specific requirements from OEM manufactures.

WO2009/024351A1 disclosed a paint composition comprising hydroxyl group containing resin (A) having a hydroxyl value of from 80 to 220 mgKOH/g, a glass transition temperature of −50° C. or above but below 0° C. and from 25 to 55 mass % of 4-hydroxybutyl (meth)acrylate monomeric units, hydroxyl group containing resin (B) having a hydroxyl value of from 80 to 220 mgKOH/g and a glass transition temperature of from 0 to 50° C., and crosslinking agent (C) comprising polyisocyanate compound. The paint composition of this invention is applied as a top-coat paint in the un-crosslinked state and baked at 140° C. for 30 min to prepare samples. In this invention, it needs relative higher baking temperature to crosslinking the top-coat paint.

CN109476933A disclosed a bilayer coating system comprising a first layer comprising a water-borne coating composition and a second layer comprising a solvent-borne coating composition, wherein a catalyst in the water-borne coating composition catalyzes a crosslinking reaction of the solvent-borne coating composition but not catalyze a crosslinking reaction of the waterborne coating composition, and a catalyst in the solvent-borne coating composition catalyzes a crosslinking reaction of the waterborne coating composition but not catalyze a crosslinking reaction of the solvent-borne coating composition, wherein the solvent-borne and the water-borne coating compositions can cure within 20 minutes at a temperature from 80° C. to 120° C. While the coating compositions of this invention can cure at a relative lower temperature, the bilayer coating system is complex and two different catalysts need to be used.

Therefore, it is still required to provide a coating composition having high solid content and low viscosity simultaneously from which the obtained or obtainable clearcoat layers show high initial gloss, good appearance and sufficient hardness even baked at a lower temperature.

### SUMMARY OF THE INVENTION

In one aspect, the present invention provides a 2K clearcoat coating composition comprising Component I comprising
(A) a first resin having at least one primary hydroxyl group selected from hydroxyl alkyl (meth)acrylate resins having C₁-C₁₀ and preferably C₂-C₆ alkyl groups,
(B) a second resin having at least one secondary hydroxyl group selected from hydroxyl alkyl (meth)acrylate resins having C₂-C₁₀ and preferably C₂-C₆ alkyl groups, and
(C) at least one amino resin, and
   Component II comprising
(D) at least one polyisocyanate,
   wherein the first resin has a hydroxyl value in a range of from 100 to 250 mgKOH/g and a weight average molecular weight in a range of from 3,000 to 15,000, and the second resin has a hydroxyl value in a range of from 150 to 500 mgKOH/g and a weight average molecular weight in a range of from 500 to 2,500.

In another aspect, the present invention provides an article coated by the invented coating composition.

It is surprising to find that the coating composition of the present invention has low VOC and low viscosity simultaneously, and moreover the invented coating composition is fitting low baker temperatures such as 110° C. The obtained or obtainable clearcoat layers show high initial gloss, good appearance and sufficient hardness even baked at a lower temperature.

### DETAILED DESCRIPTION OF THE INVENTION

The present invention will be described in detail hereinafter. It is to be understood that the present invention can be embodied in many different ways and shall not be construed as limited to the embodiments set forth herein.

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article or component.

As used herein, the terms “comprise”, “comprising”, etc. are used interchangeably with “contain”, “containing”, etc. and are to be interpreted in a non-limiting, open manner. That is, e.g., further components or elements can be present. The expressions “consists of” or “consists essentially of” or cognates can be embraced within “comprises” or cognates.

Unless otherwise identified, all percentages (%) are “percent by weight” and parts indicate parts by weight and “%” and “wt. %” are used alternatively in the text.

In the present invention, “(meth)acrylate” means acrylate and methacrylate, “(meth)acrylic” means acrylic acid and methacrylic acid, “(meth)acrylamide” means acrylamide and methacrylamide, “acrylic resin” includes acrylic resin and methacrylic resin, and “acrylic monomer” includes acrylic monomer and methacrylic monomer.

In the present invention, the acid value (AV) is determined in accordance with DIN EN ISO 2114 (date: June 2002), the hydroxyl value (OH value or OHV) is determined in accordance with DIN 53240-2 (date: November 2007), the solid content was determined in accordance with DIN EN ISO 3251 (date: June 2008). the weight average molecular weights are determined in accordance with DIN 55672-1 (date: August 2007).

In the present invention, the glass transition temperature of a copolymer is the numerical value calculated using the equation indicated below:

$$1 / Tg ( K ) = \sum ( mi / Tgi )$$

$$Tg ( ° C . ) = Tg ( K ) - 273$$

Tg: Glass transition temperature of the copolymer
mi: Mol fraction of the monomer component i
Tgi: Glass transition temperature (K) of a homopolymer of the monomer component i.

In addition, glass transition temperature (K) of a homopolymer of the monomer component i is based on the value obtained by POLYMER HANDBOOK Fourth Edition, J. Brandrup, E.h. Immergut, E. A. Grulke, ed. (1999). For homopolymers of a monomer not described in this document, the glass transition temperature may be determined by synthesizing a homopolymer of the monomer with a weight average molecular weight of about 50,000 and measuring the glass transition temperature by differential scanning thermal analysis.

### First Resin

The first resin has at least one primary hydroxyl group. Preferably, the first resin has at least 60% by mole of primary hydroxyl group based on the total hydroxyl group of the first resin, such as at least 70% by mole, at least 80% by mole, at least 90% by mole and 100% by mole of primary hydroxyl group.

The first resin has a Tg (glass transition temperature) in a range of from 10° C. to 80° C., preferably from 10° C. to 60° C., more preferably from 12° C. to 45° C., such as 10° C., 15° C., 20° C., 25° C., 30° C., 35° C., 40° C., 45° C., 50° C., 55° C., 60° C., 65° C., 70° C. and 75° C., etc.

The first resin has a hydroxyl value in a range of from 100 to 250 mgKOH/g, preferably from 120 to 185 mgKOH/g, such as 110 mgKOH/g, 120 mgKOH/g, 130 mgKOH/g, 140 mgKOH/g, 160 mgKOH/g, 170 mgKOH/g, 180 mgKOH/g, 190 mgKOH/g, 210 mgKOH/g, 220 mgKOH/g, 230 mgKOH/g and 240 mgKOH/g, etc.

The first resin has a weight average molecular weight in a range of from 3,000 to 15,000, preferably from 3,500 to 12,000, such as 3,000, 4,000, 5,000, 6,000, 7,000, 8,000, 9,000, 10,000, 11,000, 12,000, 13,000 and 14,000, etc.

In one preferred embodiment of the present invention, the first resin is an acrylic resin containing at least one primary hydroxyl group in the molecule.

The acrylic resin containing at least one primary hydroxyl group can be synthesized by copolymerizing a primary hydroxyl-containing acrylic monomer and other copolymerizable monomers by a conventional method such as radical polymerization.

Examples of the primary hydroxyl-containing acrylic monomers include hydroxyl alkyl (meth)acrylates with C₁ to C₁₀ and preferably C₂ to C₆ alkyl group, such as 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, and ethylene oxide and/or propylene oxide adducts of 2-hydroxyethyl (meth)acrylate, 3-hydroxypropyl (meth)acrylate or 4-hydroxybutyl (meth)acrylate, preferably 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, or combination thereof, more preferably 2-hydroxyethyl acrylate (2-HEA), 2-hydroxyethyl methacrylate (2-HEMA), 3-hydroxypropyl acrylate (3-HPA), 3-hydroxypropyl methacrylate (3-HPMA), 4-hydroxybutyl acrylate (4-HBA), and 4-hydroxybutyl methacrylate (4-HBMA). The primary hydroxyl-containing acrylic monomers can be used alone or in combination of two or more monomers.

Examples of the other copolymerizable monomers include C₁-C₂₀-alkyl (meth)acrylate, preferably C₁-C₁₀-alkyl (meth)acrylate, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, lauryl (meth)acrylate, isobornyl (meth)acrylate, stearyl (meth)acrylate, cyclohexyl methacrylate (CHMA); styrene; (meth)acrylic acid; maleic acid; caprolactone; maleic anhydride; N, N-dimethylaminoethyl (meth)acrylate; N,N-diethylaminoethyl (meth)acrylate; N,N-dimethylaminopropyl (meth)acrylate; aminoalkyl (meth)acrylate; (meth)acrylamide or its derivatives, such as N,N-dimethylaminoethyl(meth)acrylamide, N,N-diethylaminoethyl(meth)acrylamide, N,N-dimethylaminopropyl (meth)acrylamide, N-methylol acrylamide, N-methylol acrylamide methyl ether, N-methylol acrylamide butyl ether. The other copolymerizable monomers can be used alone or in combination of two or more monomers to react with the primary hydroxyl-containing acrylic monomers in the polymerization.

Preferably, the other copolymerizable monomer is at least one selected from a group consisting of methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, (meth)acrylic acid, caprolactone, styrene or combination thereof, preferably methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, (meth)acrylic acid, caprolactone and styrene.

The first resin comprises at least 60%, preferably at least 70% and more preferably at least 80% by weight of units derived from acrylic monomer, such as 60 wt. %, 65 wt. %, 70 wt. %, 75 wt. %, 80 wt. %, 85 wt. %, 90 wt. % and 95 wt. %, etc., based on the total weight of the first resin. Said acrylic monomers include any acrylic monomers having at least one primary hydroxyl group and other copolymerizable acrylic monomers.

In one preferred embodiment of the present invention, the first resin comprises from 60% to 90% by weight of units derived from acrylic monomer, such as from 65% to 85% by weight, and from 70% to 80% by weight, etc., based on the total weight of the first resin.

The first resin comprises from 20% to 50% and preferably from 25% to 45% by weight of units derived from the primary hydroxyl-containing acrylic monomers, such as 30 wt. %, 35 wt. % and 40 wt. %, etc., based on the total weight of the first resin.

The first resin comprises from 50% to 80% and preferably from 55% to 75% by weight of units derived from the other copolymerizable monomer, such as 60 wt. %, 65 wt. % and 70 wt. %, etc., based on the total weight of the first resin.

Preferably, the first resin has an acid value in a range of from 0 to 20 KOH/mg/g, preferably from 2 to 20 KOH/mg/g, such as 5 KOH/mg/g, 10 KOH/mg/g and 15 KOH/mg/g, etc.

The 2K coating composition comprises from 10% to 70% and preferably from 20% to 50% by weight of the first resin, such as 10 wt. %, 20 wt. %, 30 wt. %, 40 wt. %, 50 wt. %, 60 wt. % and 70 wt. %, etc. based on the total weight of the coating composition.

The first resin can be produced by a conventional method such as radical polymerization. Examples of the radical polymerization initiator include azo compounds such as 2,2′-azobisisobutyronitrile, 2,2′-azobis-2,4-dimethyl-valeronitrile, 4,4′-azobis-4-cyanovaleric acid, 1-azobis-1-cyclohexanecarbonitrile, dimethyl-2,2′-azobisisobutyrate and the like, and organic peroxides such as methyl ethyl ketone peroxide, cyclohexanone peroxide, 3,5,5-trimethylhexanone peroxide, 1,1-bis(t-butylperoxy)-3,3,5-trimethylcyclohexane, 1,1-bis(t-butylperoxy)-cyclohexane, 2,2-bis(t-butylperoxy)octane, t-butylhydroperoxide, diisopropyl benzenehydroperoxide, dicumyl peroxide, di-tert-butyl peroxide (DTBP), t-butylcumyl peroxide, isobutyl peroxide, lauroyl peroxide, benzoyl peroxide, diisopropylperoxydicarbonate, tertiary butylperoxy-2-ethylhexanoate (TBPEH), t-butylperoxy neodecanate, t-butylperoxy laurate, t-butylperoxy benzoate, t-butylperoxy isopropylcarbonate and the like. One of these radical polymerization initiators can be used alone, or a combination of two or more types can be used.

No particular limitation is imposed upon the amount of radical polymerization initiator, but an amount of from 0.01% to 20% by weight based on the total weight of radically polymerizable monomer is preferred.

Examples of appropriate organic solvents which can be used in the production of the first resin include aliphatic hydrocarbon based solvents such as cyclohexane, ethylcyclo hexane and the like, aromatic hydrocarbon based solvents such as toluene, xylene, ethylbenzene, aromatic naphtha and the like, ketone based solvents such as acetone, methyl ethyl ketone, methyl isobutyl ketone, cyclohexanone, isophorone and the like, ester based solvents such as ethyl acetate, n-butyl acetate, isobutyl acetate, 3-methoxybutyl acetate, bis(2-ethylhexyl) adipate and the like, ether based solvents such as dibutyl ether, tetrahydrofuran, 1, 4-dioxane, 1, 3, 5-trioxane and the like, and nitrogen containing solvents such as acetonitrile, valeronitrile, N,N-dimethyl-formamide, N,N-diethylformamide and the like. The organic solvent can be of one type, or it can be a mixed solvent comprising a plurality of two or more types.

The method of adding the organic solvent and the radical polymerization initiator when producing the first resin is optional, but with a view to controlling the heat of polymerization and the heat of reaction, the method in which an organic solvent is introduced into the reactor and the radically polymerizable monomer or an organic solution thereof is drip-fed from a drop-feed tank, with stirring is preferred.

The polymerization temperature of the above-mentioned polymerization reaction differs according to the type of radical polymerization initiator, but it is preferably carried out at a temperature in a range of from 50° C. to 200° C., more preferably from 100° C. to 160° C., such as 60° C., 70° C., 80° C., 90° C., 100° C., 110° C., 120° C., 130° C., 140° C., 150° C., 160° C., 170° C., 180° C. and 190° C., etc.

### Second Resin

There is no specific definition for Tg of the second resin. In one embodiment of the present invention, the second resin has a Tg in a range of from −50° C. to 150° C., such as −40° C., −30° C., −20° C., −10° C., 0° C., 10° C., 20° C., 30° C., 40° C., 50° C., 60° C., 70° C., 80° C., 90° C., 100° C., 110° C., 120° C., 130° C. and 140° C., etc.

The second resin has a hydroxyl value in a range of from 150 to 500 mgKOH/g, preferably from 200 to 300 mgKOH/g, such as 150 mgKOH/g, 200 mgKOH/g, 250 mgKOH/g, 300 mgKOH/g, 350 mgKOH/g, 400 mgKOH/g and 450 mgKOH/g, etc.

The second resin has a weight average molecular weight of less than 3,000, preferably in a range of from 500 to 2,500, such as 1,000, 1,500 and 2,000, etc.

In one preferred embodiment of the present invention, the second resin is an acrylic resin containing at least one secondary hydroxyl group in the molecule.

The second resin comprises monomeric units derived from hydroxyl alkyl (meth) acrylates having C₂-C₁₀ and preferably C₂-C₆ alkyl group.

The acrylic resin containing at least one secondary hydroxyl group can be synthesized by copolymerizing a secondary hydroxyl-containing acrylic monomer and optional a primary hydroxyl-containing acrylic monomer and other copolymerizable monomers by a conventional method such as radical polymerization.

Examples of the secondary hydroxyl-containing acrylic monomers include hydroxyl alkyl (meth) acrylates with the alkyl having a carbon atom number in the range of from 2 to 10, preferably in the range of from 2 to 6, such as 1-hydroxylethyl (meth)acrylate, 1- or 2-hydroxypropyl (meth)acrylate, 1-, 2- or 3-hydroxy butyl (meth)acrylate, 1-, 2-, 3- or 4-hydroxypentyl (meth)acrylate, 1-, 2-, 3-, 4- or 5-hydroxyhexyl (meth)acrylate, 1-, 2-, 3-, 4-, 5- or 6-hydroxyheptyl (meth)acrylate, 1-, 2-, 3-, 4-, 5-, 6- or 7-hydroxyoctyl (meth)acrylate, and ethylene oxide and/or propylene oxide adducts of 1-hydroxylethyl (meth)acrylate, 1- or 2-hydroxypropyl (meth)acrylate, 1-, 2- or 3-hydroxy butyl (meth)acrylate, preferably 1-hydroxyethyl (meth)acrylate, 1- or 2-hydroxypropyl (meth)acrylate and 1-, 2- or 3-hydroxybutyl methacrylate. The secondary hydroxyl-containing acrylic monomers can be used alone or in combination of two or more monomers.

Preferably, the secondary hydroxyl-containing acrylic monomer is at least one selected from a group consisting of 1-hydroxyethyl acrylate (1-HEA), 1-hydroxyethyl methacrylate (1-HEMA), 1- or 2-hydroxypropyl acrylate (1- or 2-HPA), 1- or 2-hydroxypropyl methacrylate (1- or 2-HPMA), 1-, 2- or 3-hydroxybutyl acrylate (1-, 2- or 3-HBA) and 1-, 2- or 3-hydroxybutyl methacrylate (1-, 2- or 3-HBMA), and more preferably 2-hydroxypropyl methacrylate (2-HPMA).

Examples of the primary hydroxyl-containing acrylic monomers include hydroxyl alkyl (meth)acrylates with C₁ to C₁₀ and preferably C₂ to C₆ alkyl group, such as 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, and ethylene oxide and/or propylene oxide adducts of 2-hydroxyethyl (meth)acrylate, 3-hydroxypropyl (meth)acrylate, 4-hydroxybutyl (meth)acrylate, preferably 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, or combination thereof, more preferably 2-hydroxyethyl acrylate (2-HEA), 2-hydroxyethyl methacrylate (2-HEMA), 3-hydroxypropyl acrylate (3-HPA), 3-hydroxypropyl methacrylate (3-HPMA), 4-hydroxybutyl acrylate (4-HBA), and 4-hydroxybutyl methacrylate (4-HBMA). The primary hydroxyl-containing acrylic monomers can be used alone or in combination of two or more monomers. Examples of the other copolymerizable monomers include C₁-C₂₀-alkyl (meth)acrylate, preferably C₁-C₁₀-alkyl (meth)acrylate, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, lauryl (meth)acrylate, isobornyl (meth)acrylate, stearyl (meth)acrylate, cyclohexyl methacrylate (CHMA); styrene; (meth)acrylic acid; maleic acid; maleic anhydride; N, N-dimethylaminoethyl (meth)acrylate; N,N-diethylaminoethyl (meth)acrylate; N,N-dimethylaminopropyl (meth)acrylate; aminoalkyl (meth)acrylate; (meth)acrylamide or its derivatives, such as N,N-dimethylaminoethyl(meth)acrylamide, N,N-diethylaminoethyl(meth)acrylamide, N,N-dimethylaminopropyl (meth)acrylamide, N-methylol acrylamide, N-methylol acrylamide methyl ether, N-methylol acrylamide butyl ether. The other copolymerizable monomers can be used alone or in combination of two or more monomers to react with the hydroxyl-containing acrylic monomers in the polymerization.

Preferably, the other copolymerizable monomers is at least one selected from a group consisting of methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, (meth)acrylic acid, styrene or combination thereof, preferably methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, (meth)acrylic acid and styrene.

The second resin comprises at least 70%, preferably at least 80% and more preferably at least 90% by weight of units derived from acrylic monomer, such as 75 wt. %, 80 wt. %, 85 wt. %, 90 wt. % and 95 wt. %, etc., based on the total weight of the second resin. Said acrylic monomers include any hydroxyl-containing acrylic monomers and other copolymerizable acrylic monomers.

In one preferred embodiment of the present invention, the second resin comprises from 85% to 95% by weight of units derived from acrylic monomer, based on the total weight of the second resin.

The second resin comprises from 30% to 70% and preferably from 40% to 60% by weight of units derived from hydroxyl-containing acrylic monomers, preferably secondary hydroxyl-containing acrylic monomers, such as 50 wt. %, based on the total weight of the second resin.

The second resin comprises from 30% to 70% and preferably from 40% to 60% by weight of units derived from the other copolymerizable monomer, such as 50 wt. %, based on the total weight of the second resin.

In one embodiment, the second resin is a resin having at least one secondary hydroxyl group and at least one primary hydroxyl group, wherein the ratio by mole of the secondary hydroxyl group to the primary hydroxyl group in the second resin is in a range of from 2:1 to 10:1, preferably 3:1 to 5:1, such as 2:1, 3:1, 4:1, 5:1, 6:1, 7:1, 8:1 and 9:1 etc.

Preferably, the second resin has an acid value in a range of from 0 to 30 KOH/mg/g, such as 5 KOH/mg/g, 10 KOH/mg/g and 15 KOH/mg/g, etc.

The coating composition comprises from 2% to 20% and preferably from 5% to 15% by weight of the second resin, such as 5 wt. %, 10 wt. %, 15 wt. % and 20 wt. %, etc., based on the total weight of the coating composition.

The ratio by weight between the first resin and the second resin in the coating composition is in a range of from 2:1 to 10:1, preferably from 3:1 to 5:1, such as 2:1, 3:1, 4:1, 5:1, 6:1, 7:1, 8:1 and 9:1, etc.

The second resin can be produced by a conventional method such as radical polymerization, and the method for preparing the first resin is also applicable for the second resin.

Preferably, the sum of the first resin and the second resin is in a range of from 40% to 80% by weight based on the total weight of the coating composition, such as 42 wt. %, 43 wt. %, 44 wt. %, 45 wt. %, 46 wt. %, 47 wt. %, 48 wt. %, 49 wt. %, 50 wt. %, 55 wt. %, 60 wt. %, 65 wt. %, 70 wt. % and 75 wt. %, etc., based on the total weight of the coating composition.

### Amino Resin

The amino resins are condensation products of aldehydes, especially formaldehyde, with, for example, urea, melamine, guanamine and benzoguanamine. The amino resins contain alcohol groups, preferably methylol groups, which in general are partly or, preferably, fully etherified with alcohols. In particular, the use is made of melamine-formaldehyde resins etherified with lower alcohols, particularly with methanol or butanol. Very particular preference is given to using as crosslinkers melamine-formaldehyde resins which are etherified with lower alcohols, especially with methanol and/or ethanol and/or butanol.

In this context, it is possible to use any amino resins suitable for transparent topcoat or clearcoat materials, or a mixture of such resins. Particularly suitable are the conventional amino resins, some of whose methylol and/or methoxymethyl groups have been defunctionalized by means of carbamate or allophanate groups.

A preferred amino resin is melamine resin as a crosslinker. Crosslinkers of this kind are described in patents U.S. Pat. No. 4,710,542 A and EP 0 245 700 B1 and also in the article by B. Singh and Coworkers, “Carbamylmethylated Melamines, Novel Crosslinkers for the Coatings Industry” in Advanced Organic Coatings Science and Technology Series, 1991, Volume 13, pages 193 to 207. On the melamine resins reference may also be made to Rompp Lexikon Lacke und Druckfarben, 1988, pages 374 and 375, “Melamine resins” and to the book “Lackadditive” [Additives for Coatings] by Johan Bieleman, 1988, pages 242 to 250, section on “Melamine-resin-crosslinking systems”.

Melamine resins are well known to the skilled person and are supplied by numerous companies as sales products. Examples of suitable, low molecular mass, fully etherified melamine resins are Cymel® 301 and 303 from Cytec, Luwipal® 066 from BASF Aktiengesellschaft, Resimene® and Maprenal® MF from Solutia.

Examples of suitable, comparatively low molecular mass, highly etherified melamine resins containing free imino groups are Cymel® 325 and 327 (methanol-etherified), Cymel® 202 and 203 (methanol-& butanol-etherified mixture) and 1158 (butanol-etherified) from Cytec, Luwipal® 062 (methanol-etherified), 018 (butanol-etherified), and 014 (butanol-etherified, of relatively high viscosity) from BASF Aktiengesellschaft, Maprenal® MF 927 and 3950 (methanol-etherified), VMF 3611 and 3615 (butanol-etherified) and 580 (isobutanol-etherified), and also Resimene® 717 and 718 (methanol-etherified), and 750 and 5901 (butanol-etherified), and also MB 9539 from Solutia and Setamine® US 138 and US 146 (butanol-etherified) from Akzo Resins. Examples of suitable, comparatively low molecular mass, partially etherified melamine resins are Luwipal® 012, 016, 015, 018 and 010 from BASF Aktiengesellschaft, Maprenal® MF 590 and 600 from Solutia and Setamine® US 132 and 134 from Akzo Resins.

The amount of the amino resin is in a range of from 1% to 30%, preferably from 5% to 15% by weight, based on the total weight of the coating composition, such as 3 wt. %, 8 wt. %, 10 wt. %, 12 wt. %, 16 wt. %, 18 wt. %, 20 wt. % and 25 wt. %, etc.

### Polyisocyanate

The polyisocyanate having at least two and preferably at least three isocyanate groups can be used as a crosslinker in the coating composition of the present invention, and one type or a combination of two or more types of polyisocyanate can be used.

Examples of polyisocyanate having at least two isocyanate groups per molecule include aliphatic, cycloaliphatic, araliphatic and/or aromatic isocyanates, such as 1,4-tetra-methylenediisocyanate, hexamethylenediisocyanate (HDI), 2,2,4-trimethylhexane-1,6-diisocyanate, methylcyclohexyl-diisocyanate, p-phenylenediisocyanate, biphenyldiisocyanate, tolylenediisocyanate, 3,3′-dimethyl-4,4′-biphenylenediisocyanate, methylenebis(phenylisocyanate), lysine methyl ester diisocyanate, 1-isocyanato-3,3,5-trimethyl-5-isocyanatomethylcyclohexane (isophorone diisocyanate, IPDI), 2-isocyanatoethyl-2,6-diisocyanatohexanoate, 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate, the biuret forms, isocyanurate forms of these compounds, oligomeric or polymeric isocyanates, or a mixture thereof.

In one preferred embodiment, the polyisocyanate is an aliphatic polyisocyanate, such as Desmodur N100, N75, N3200, N3400, N3600, Desmodur 3390 and DesmodurZ4470 from Covestro. In one preferred embodiment, the polyisocyanate is an oligomeric isocyanate compound, such as isocyanate dimers, isocyanate trimers, etc. In one particular embodiment, the polyisocyanate is a trimer of HDI, such as Desmodur 3390 from Covestro.

The ratio by mole between NCO groups in polyisocyanate and hydroxyl groups in both of the first resin and the second resin is in a range of from 0.7:1 to 1.6:1 and preferably from 1.1:1 to 1.3:1.

In one particular embodiment according to the present invention, the 2K clearcoat coating composition comprises Component I comprising
(A) from 15% to 75% and preferably from 25% to 60% by weight of a first resin having at least one primary hydroxyl group selected from hydroxyl alkyl (meth)acrylate resins having C₁-C₁₀ and preferably C₂—C alkyl groups,
(B) from 2% to 25% and preferably from 5% to 15% by weight of a second resin having at least one secondary hydroxyl group selected from hydroxyl alkyl (meth)acrylate resins having C₂-C₁₀ and preferably C₂-C₅ alkyl groups, and
(C) at least one amino resin, and
   Component II comprising
(D) at least one polyisocyanate,
   wherein the first resin has a Tg of from 10° C. to 80° C., a hydroxyl value in a range of from 100 to 190 mgKOH/g and a weight average molecular weight in a range of from 3,000 to 15,000, and the second resin has a hydroxyl value in a range of from 150 to 500 mgKOH/g and a weight average molecular weight in a range of from 500 to 2,500 and the total weight percentage of the first resin and the second resin is in a range of from 40% to 80% by weight based on the total weight of the coating composition.

In another particular embodiment according to the present invention, the 2K clearcoat coating composition comprises Component I comprising
(A) from 15% to 75% and preferably from 25% to 60% by weight of a first resin having at least one primary hydroxyl group selected from hydroxyl alkyl (meth)acrylate resins having C₁-C₁₀ and preferably C₂—C alkyl groups,
(B) from 2% to 25% and preferably from 5% to 15% by weight of a second resin having at least one secondary hydroxyl group selected from hydroxyl alkyl (meth)acrylate resins having C₂-C₁₀ and preferably C₂—C alkyl groups, and
(C) at least one amino resin, and
   Component II comprising
(D) at least one polyisocyanate,
   wherein the first resin has a Tg of from 10° C. to 80° C., a hydroxyl value in a range of from 120 to 140 mgKOH/g and a weight average molecular weight in a range of from 10,000 to 15,000, and the second resin has a hydroxyl value in a range of from 150 to 500 mgKOH/g and a weight average molecular weight in a range of from 500 to 2,500 and the total weight percentage of the first resin and the second resin is in a range of from 40% to 80% by weight based on the total weight of the coating composition.

In another particular embodiment according to the present invention, the 2K clearcoat coating composition comprises
Component I comprising
   (A) from 15% to 75% and preferably from 25% to 60% by weight of a first resin having at least one primary hydroxyl group selected from hydroxyl alkyl (meth)acrylate resins having C₁-C₁₀ and preferably C₂—C alkyl groups,
   (B) from 2% to 25% and preferably from 5% to 15% by weight of a second resin having at least one secondary hydroxyl group selected from hydroxyl alkyl (meth)acrylate resins having C₂-C₁₀ and preferably C₂—C alkyl groups, and
   (C) at least one amino resin, and Component II comprising
   (D) at least one polyisocyanate,
wherein the first resin has a Tg of from 10° C. to 80° C., a hydroxyl value in a range of from 140 to 190 mgKOH/g and a weight average molecular weight in a range of from 10,000 to 15,000, and the second resin has a hydroxyl value in a range of from 150 to 500 mgKOH/g and a weight average molecular weight in a range of from 500 to 2,500 and the total weight percentage of the first resin and the second resin is in a range of from 40% to 80% by weight based on the total weight of the coating composition.

In another particular embodiment according to the present invention, the 2K clearcoat coating composition comprises
Component I comprising
   (A) from 15% to 75% and preferably from 25% to 60% by weight of a first resin having at least one primary hydroxyl group selected from hydroxyl alkyl (meth)acrylate resins having C₁-C₁₀ and preferably C₂—C alkyl groups,
   (B) from 2% to 25% and preferably from 5% to 15% by weight of a second resin having at least one secondary hydroxyl group selected from hydroxyl alkyl (meth)acrylate resins having C₂-C₁₀ and preferably C₂-C₆ alkyl groups, and
   (C) at least one amino resin, and Component II comprising
   (D) at least one polyisocyanate,
wherein the first resin has a Tg of from 10° C. to 80° C., a hydroxyl value in a range of from 190 to 250 mgKOH/g and a weight average molecular weight in a range of from 3,000 to 5,000, and the second resin has a hydroxyl value in a range of from 150 to 500 mgKOH/g and a weight average molecular weight in a range of from 500 to 2,500 and the total weight percentage of the first resin and the second resin is in a range of from 40% to 80% by weight based on the total weight of the coating composition.

In another particular embodiment according to the present invention, the 2K clearcoat coating composition comprises
Component I comprising
   (A) from 15% to 75% and preferably from 25% to 60% by weight of a first resin having at least one primary hydroxyl group selected from hydroxyl alkyl (meth)acrylate resins having C₁-C₁₀ and preferably C₂—C alkyl groups,
   (B) from 2% to 25% and preferably from 5% to 15% by weight of a second resin having at least one secondary hydroxyl group selected from hydroxyl alkyl (meth)acrylate resins having C₂-C₁₀ and preferably C₂—C alkyl groups, and
   (C) at least one amino resin, and Component II comprising
   (D) at least one polyisocyanate,
wherein the first resin has a Tg of from 10° C. to 80° C., a hydroxyl value in a range of from 190 to 250 mgKOH/g and a weight average molecular weight in a range of from 5,000 to 10,000, and the second resin has a hydroxyl value in a range of from 150 to 500 mgKOH/g and a weight average molecular weight in a range of from 500 to 2,500 and the total weight percentage of the first resin and the second resin is in a range of from 40% to 80% by weight based on the total weight of the coating composition.

Various additives can be added, for example, levelling agent, sag control agent, defoamer, light stabilizer, ultraviolet absorber, coloring agent, antioxidant, surfactant, surface controlling agent, hardening reaction catalyst, anti-static agent, perfume, de-watering agent and rheology controlling agents such as polyethylene wax, polyamide wax, fine internally crosslinked type resin particles and the like, as required.

The coating compositions of the present invention can be used as clearcoat, or color paints with addition of dyes and pigments etc.

The application of the invented coating composition is carried out by using any approach in the prior art, such as air sprayer, electrostatic air sprayer, roll coater, flow coater or dipping or a brush or a bar coater, or applicator or the like. And spray painting is preferred in this invention.

No limitation is imposed upon the thickness of a paint film obtained by applying the invented coating composition, but the thickness of paint films after drying is preferably in a range of from 10 μm to 150 μm and more preferably from 30 μm to 60 μm.

Furthermore, examples of the substrate materials for painting the invented coating composition include both inorganic materials and organic materials such as metal, wood, glass, cloth, plastics, foams, elastomers, paper, ceramics, concrete, plaster-board and the like, and metal substrates are preferred. These substrate materials can be with or without pre-treatment.

Examples of the obtained or obtainable coated articles include metal products, structural materials, wooden products, plastic products, rubber products, paper products, ceramic products, glass products and the like, and more specifically, they include automobiles and automobile parts (for example bodies, bumpers, spoilers, mirrors, wheels, interior decorative parts and the like, which are made of a variety of materials), metal sheets such as steel sheets, bicycles, bicycle parts, materials used on roads (for example guard rails, traffic signs, sound-deadening walls and the like), materials used in tunnels (for example side wall panels and the like), ships, railway rolling stock, aircraft, furniture, musical instruments, domestic electrical goods, building materials, containers, office accessories, sports accessories, toys and the like and metal products are preferred.

### EMBODIMENTS

Although the following detailed description gives specific preferred embodiments, the persons skilled in the art should understand that these embodiments are only for example and the present invention can be practiced in alternative ways.

### Embodiment 1

A 2K clearcoat coating composition comprising
Component I comprising
   (A) a first resin having at least one primary hydroxyl group selected from hydroxyl alkyl (meth)acrylate resins having C₁-C₁₀ and preferably C₂-C₆ alkyl groups,
   (B) a second resin having at least one secondary hydroxyl group selected from hydroxyl alkyl (meth)acrylate resins having C₂-C₁₀ and preferably C₂-C₅ alkyl groups, and
   (C) at least one amino resin, and
Component II comprising
   (D) at least one polyisocyanate,
wherein the first resin has a hydroxyl value in a range of from 100 to 250 mgKOH/g and a weight average molecular weight in a range of from 3,000 to 15,000, and the second resin has a hydroxyl value in a range of from 150 to 500 mgKOH/g and a weight average molecular weight in a range of from 500 to 2,500.

### Embodiment 2

The coating composition according to embodiment 1, wherein said first resin has a Tg in a range of from 10° C. to 80° C. and preferably from 10° C. to 45° C.

### Embodiment 3

The coating composition according to any one of embodiments 1 to 2, wherein said first resin has an acid value in a range of from 0 to 20 and preferably from 2 to 20.

### Embodiment 4

The coating composition according to any one of embodiments 1 to 3, wherein said first resin has a weight average molecular weight in a range of from 3,500 to 12,000.

### Embodiment 5

The coating composition according to any one of embodiments 1 to 4, wherein said first resin has a hydroxyl value in a range of from 190 to 250 mgKOH/g and a weight average molecular weight in a range of from 3,000 to 10,000.

### Embodiment 6

The coating composition according to any one of embodiments 1 to 4, wherein said first resin has a hydroxyl value in a range of from 100 to 190 mgKOH/g and a weight average molecular weight in a range of from 3,000 to 15,000.

### Embodiment 7

The coating composition according to any one of embodiments 1 to 6, wherein said second resin has a hydroxyl value in a range of from 200 to 300 mgKOH/g.

### Embodiment 8

The coating composition according to any one of embodiments 1 to 7, wherein said second resin further comprises at least one primary hydroxyl group.

### Embodiment 9

The coating composition according to embodiment 8, wherein the ratio by mole of the secondary hydroxyl group to the primary hydroxyl group in the second resin is in a range of from 2:1 to 10:1, preferably 3:1 to 5:1.

### Embodiment 10

The coating composition according to any one of embodiments 1 to 9, wherein the ratio by mole between NCO groups in Component (D) and the total hydroxyl groups in Components (A) and (B) is in a range of from 0.7:1 to 1.6:1 and preferably from 1.1:1 to 1.3:1.

### Embodiment 11

The coating composition according to any one of claims 1 to 10, wherein the weight percentage of Component (A) is in a range of from 15% to 75% and preferably from 25% to 60%, and the percentage of Component (B) is in a range of from 2% to 25% and preferably from 5% to 15%, and the total weight percentage of Component (A) and (B) is in a range of from 40% to 80% and preferably from 44% to 60%, based on the total weight of the coating composition.

### Embodiment 12

The coating composition according to any one of embodiments 1 to 11, wherein the weight percentage of said amino resin is in a range of from 1% to 30% and preferably from 5% to 15%, based on the total weight of the coating composition.

### Embodiment 13

The coating composition according to any one of embodiments 1 to 12, wherein said amino resin is melamine resin.

### Embodiment 14

An article coated by the coating composition according to any one of embodiments 1 to 13.

### EXAMPLES

The invention is described in more practical terms below by means of illustrative examples, but the invention is not limited in any way by these illustrative examples.

The performance of the paint films obtained with coating compositions of the present invention was determined in the ways indicated below.

### Performance Tests on Clearcoat

### (1) Tukon Hardness

Hardness of the coating is evaluated by Tukon hardness, which follows the ASTM D1474 using Wilson Tukon 1102 tester.

### (2) Appearance

The appearance of dried and cured clearcoat is evaluated by its surface texture, which is measured by BYK wave-scan dual. Surface texture is a mixture of various textures, ranging from very fine to very course. BYK wave-scan dual measures the surface textures at different scale levels, which is differentiated to six categories, identified by wavelength (Du, Wa, Wb, Wc, Wd, We). Based on these measured data, Lw, Sw, DOI are calculated by the equipment and denotes the appearance level of the paint. A lower Lw and Sw and a higher DOI value represents a better performance in appearance. Lw is majorly defined by the clearcoat layer, while Sw and DOI is not only defined by clearcoat layer, but also substrate and basecoat. Usually, a good appearance performance is defined by Lw<5 and Sw<15 at the same time.

### (3) Gloss

Gloss of coating surface is measured with BYK Haze-Gloss meter at the angle of 20° following DIN 67530 method. Automotive coating is a type of high gloss coating, in which application, higher gloss is better for end application.

### (4) VOC

VOC is evaluated according to the method described in GB/T 38597/2020, GB/T 1725-2007 and GB/T 23985-2009 based on solid content measurement. Solid content is measured by the following process: 1 g of sample is weighed in an aluminum pan with the diameter of 75 mm, which is subsequently baked at 105° C. for 1h. VOC calculation is preceded following the equation listed below. For all the inventive samples and comparative samples listed in this invention, ρ, the density of coating sample measured is 0.97 g/mL.

$$ρ ( VOC ) = ( 100 - NV ) \times ρ \times 10$$

$$ρ ( VOC ) = sample VOC ( calculated ) , g / mL$$

NV=sample solid content, expressed in mass fraction (%)
p=the density of the coating sample measured at 23° C., g/mL

### Materials

Setalux® 91756 VS-60 YA is a sag control agent from Allnex
Cymel® 202 is an amino resin crosslinker from Allnex
Cycat® 4045 is a catalyst from Allnex
Disperbyk® 110 is a leveling agent from BYK Chemie
BYK® 325N is a leveling agent from BYK Chemie
BYK® 315N is a leveling agent from BYK Chemie
BYK® 355 is a leveling agent from BYK Chemie
BYK® ES 80 is a conductive additive from BYK Chemie
Disparlon® OX-883HF is a defoamer from King Industries
Tinuvin® 5248 is a light stabilizer from BASF
Desmodur 3390 is a polyisocyanate crosslinker from Covestro

The first resins in the following preparation examples are prepared according to the monomer compositions and ratios by weight shown in Table 1.

TABLE 1
Monomer compositions of first resins

| First | | | n- | n- | 2- | 2- | |
|---|---|---|---|---|---|---|---|
| Resin | St | CHMA | BA | BMA | HEA | HEMA | AA |
| 1 | 24.4 | 20 | 5.8 | 19.8 | 29 | 0 | 0 |
| 2 | 24.4 | 35.8 | 0 | 3.6 | 35.2 | 0 | 0 |
| 3 | 24.4 | 30.7 | 0 | 0 | 20.7 | 23.2 | 0 |
| 4 | 24.4 | 28.3 | 0 | 15.1 | 14.5 | 16.2 | 1 |
| 5 | 24.4 | 15.8 | 0 | 23.6 | 35.2 | 0 | 1 |
| 6 | 24.4 | 33.2 | 0 | 0 | 35.2 | 6.2 | 1 |
| 7 | 24.4 | 29.8 | 0 | 14.8 | 29 | 0 | 2 |
| 8 | 24.4 | 27.8 | 0 | 8.5 | 17.6 | 19.7 | 2 |
| 9 | 24.4 | 18.8 | 0 | 13.4 | 41.4 | 0 | 2 |

Notes:
St: Styrene;
2-HEA: 2-hydroxyl ethylacrylate;
2-HEMA: 2-hydroxyl ethyl methacrylate;
n-BA: n-butylacrylate;
n-BMA: n-butyl methacrylate;
CHMA: cyclohexyl methacrylate;
AA: acrylic acid

### Preparation Example of First Resin 1

A stainless-steel reactor equipped with reflux condenser and N₂ inlet is charged with 25.492 parts by weight of solvent naphtha 160/180 (SN), and this initial charge is heated to 160° C. with pressure held at 1.5 bar. Thereafter, over a period of 4.5 hours, an initiator solution (6 parts by weight of [di-tert-butyl peroxide (DTBP) in 1.42 parts by weight of solvent naphtha 160/180 (SN) is metered in at a uniform rate with stirring. The monomer mixture containing 24.4 parts by weight of styrene (ST), 20 parts by weight of cyclohexyl methacrylate (CHMA), 5.8 parts by weight of n-butylacrylate (n-BA), 19.8 parts by weight of n-butyl methacrylate (n-BMA) and 29 parts by weight of 2-hydroxyl ethylacrylate (2-HEA) is metered in at a uniform rate with stirring over a period of 4 hours. Afterwards, the reaction mixture is held for 1.5 hours at 150° C. pressure 1.5 bar. Then the reaction mixture is cooled to 80° C. and diluted by the addition of 0.913 parts by weight of solvent naphtha 160/180 (SN) and 7 parts by weight of N-Butyl acrylate (BA).

### Preparation Examples of First Resin 2 to First Resin 9

The preparation examples of First Resin 2 to First Resin 9 are same as First Resin 1 except for the monomer compositions, as shown in Table 1.

The features of the prepared first resins are shown in Table 2.

TABLE 2
First Resin Features

| First Resin | Tg | OHV | AV | MW | Solid content (wt %) |
|---|---|---|---|---|---|
| 1 | 12 | 123 | 5.95 | 3788 | 59.5% |
| 2 | 45 | 147 | 2.6 | 6581 | 59.2% |
| 3 | 34 | 193 | 1.98 | 10556 | 55.0% |
| 4 | 26 | 121 | 9.49 | 5150 | 60.0% |
| 5 | 24 | 153 | 8.85 | 11329 | 60.0% |
| 6 | 34 | 161 | 11.97 | 4692 | 60.4% |
| 7 | 36 | 122 | 15.16 | 10014 | 59.5% |
| 8 | 39 | 150 | 17.7 | 3935 | 59.7% |
| 9 | 26 | 182 | 18.36 | 7495 | 59.8% |

### Preparation Example of Second Resin

A stainless-steel reactor equipped with reflux condenser and N₂ inlet is charged with 27 parts by weight of solvent naphtha 160/180 (SN), and this initial charge is heated to 160° C. with pressure held at 2.5 bar. Thereafter, over a period of 4.75 hours, an initiator solution (1 parts by weight of [di-tert-butyl peroxide (DTBP) in 2.02 parts by weight of solvent naphtha 160/180 (SN) is metered in at a uniform rate with stirring. The monomer mixture containing 5 parts by weight of n-butyl methacrylate (n-BMA), 22 parts by weight of 2-ethylhexyl methacrylate (EHMA), 8 parts by weight of cyclohexyl methacrylate (CHMA), 12 parts by weight of styrene (ST), 42 parts by weight of 2-hydroxypropyl methacrylate (2-HPMA), 10 parts by weight of 4-hydroxybutyl acrylate (4-HBA) and 1 part by weight of acrylic acid (AA) is metered in at a uniform rate with stirring over a period of 4 hours. Afterwards, the reaction mixture is held for 1.5 hours at 110° C. at normal atmospheric pressure. Then the reaction mixture is cooled to 80° C. and diluted by the addition of 26.85 parts by weight of solvent naphtha 160/180 (SN). The solid content of the resulting solution of polyacrylate is 65% by weight.

### Preparation of 2K Clearcoat Coating Composition

Table 3 describes the composition of Component I for 2K clearcoat composition. All components listed in the table are mixed subsequently to obtain Component 1. To obtain Component II, Desmodur 3390 (from Covestro) was diluted to 80% by weight in a mixture of solvent naphtha and butylacetate (1:1 by weight). The ratio by mole of NCO of Component I to total OH of Component I is 1.2:1.

TABLE 3
Compositions for Component I of the 2K coating composition

| Compositions for | | | | | | | | | Comparative | | |
|---|---|---|---|---|---|---|---|---|---|---|---|
| Component I of the 2K | Examples | | | | | | | | Examples | | |
| coating compositions | 1 | 2 | 3 | 4 | 5 | 6 | 7 | 8 | 1 | 2 | 3 |
| Second Resin | 10.34 | 10.34 | 10.34 | 10.34 | 10.34 | 10.34 | 10.34 | 10.34 | 10.34 | 10.34 | 10.34 |
| First Resin 1 | 48.06 | / | / | / | / | / | / | / | / | / | / |
| First Resin 2 | / | 39.68 | / | / | / | / | / | / | / | / | / |
| First Resin 3 | / | / | / | / | / | / | / | / | 36.86 | / | / |
| First Resin 4 | / | / | 48.75 | / | / | / | / | / | / | / | / |
| First Resin 5 | / | / | / | 40.15 | / | / | / | / | / | / | / |
| First Resin 6 | / | / | / | / | 34.42 | / | / | / | / | 34.42 | 34.42 |
| First Resin 7 | / | / | / | / | / | 48.75 | / | / | / | / | / |
| First Resin 8 | / | / | / | / | / | / | 40.15 | / | / | / | / |
| First Resin 9 | / | / | / | / | / | / | / | 34.24 | / | / | / |
| Setalux ® 91756 VS-60 YA | 14 | 14 | 14 | 14 | 14 | 14 | 14 | 14 | 14 | 14 | 14 |
| Cymel ® 202 | 11 | 11 | 11 | 11 | 11 | 11 | 11 | 11 | 11 | / | 11 |
| Disperbyk ® 110 | 0.9 | 0.9 | 0.9 | 0.9 | 0.9 | 0.9 | 0.9 | 0.9 | 0.9 | 0.9 | 0.9 |
| BYK ® 325N | 0.1 | 0.1 | 0.1 | 0.1 | 0.1 | 0.1 | 0.1 | 0.1 | 0.1 | 0.1 | 0.1 |
| BYK ® 315N | 0.024 | 0.024 | 0.024 | 0.024 | 0.024 | 0.024 | 0.024 | 0.024 | 0.024 | 0.024 | 0.024 |
| Disparlon ® OX 883HF | 0.06 | 0.06 | 0.06 | 0.06 | 0.06 | 0.06 | 0.06 | 0.06 | 0.06 | 0.06 | 0.06 |
| BYK ® ES 80 | 0.03 | 0.03 | 0.03 | 0.03 | 0.03 | 0.03 | 0.03 | 0.03 | 0.03 | 0.03 | 0.03 |
| BYK ® 355 | 1 | 1 | 1 | 1 | 1 | 1 | 1 | 1 | 1 | 1 | 1 |
| Cycat ® 4045 | 0.5 | 0.5 | 0.5 | 0.5 | 0.5 | 0.5 | 0.5 | 0.5 | 0.5 | 0.5 | 0.5 |
| Tinuvin ® 5248 | 1.9 | 1.9 | 1.9 | 1.9 | 1.9 | 1.9 | 1.9 | 1.9 | 1.9 | 1.9 | 1.9 |
| Dibasicester (DBE) | 0.96 | 0.96 | 0.96 | 0.96 | 0.96 | 0.96 | 0.96 | 0.96 | 0.96 | 0.96 | 0.96 |
| n-Butanol | 1.43 | 1.43 | 1.43 | 1.43 | 1.43 | 1.43 | 1.43 | 1.43 | 1.43 | 1.43 | 1.43 |
| Xylene | 5.88 | 5.88 | 5.88 | 5.88 | 5.88 | 5.88 | 5.88 | 5.88 | 5.88 | 5.88 | 5.88 |
| Butyl Glycol Acetate | 5.82 | 5.82 | 5.82 | 5.82 | 5.82 | 5.82 | 5.82 | 5.82 | 5.82 | 5.82 | 5.82 |
| (BGA) | | | | | | | | | | | |
| Butyl Acetate | 2.496 | 2.496 | 2.496 | 2.496 | 2.496 | 2.496 | 2.496 | 2.496 | 2.496 | 2.496 | 2.496 |
| Ethyl 3-Ethoxypropionate | 5.48 | 5.48 | 5.48 | 5.48 | 5.48 | 5.48 | 5.48 | 5.48 | 5.48 | 5.48 | 5.48 |
| (EEP) | | | | | | | | | | | |
| SUM | 109.988 | 101.605 | 110.675 | 102.072 | 96.34 | 110.675 | 102.072 | 96.164 | 98.784 | 85.34 | 96.34 |

### Preparation of Dried and Cured Film

Mix Component I and Component II of each 2K coating composition and stir the mixture evenly; spray the mixture onto steel plates and bake for 20 minutes at 110° C. The coating composition in the Comparative example 2 is cured by using polyisocynanate Desmodur 3390 alone in component II without using amino resin Cymel® 202. The coating composition in the Comparative example 3 contains only component I without component II and thus the coating composition is cured alone by amino resin Cymel® 202 in component 1.

### Comparative Example 4

Comparative example 4 is a commercially available 2K clearcoat (Trademark: ProGloss) from BASF, which is sprayed onto a steel plate and baked for 20 minutes at 140° C. ProGloss uses the same type resins as component B in the coating composition of the invention but different resins from component A in the coating composition of the invention.

### Comparative Example 5

Comparative example 5 is same as Comparative example 4 except that the baking temperature is 110° C.

The evaluation of clearcoat films were performed in a multilayered coating comprising a black aqueous basecoat (or a white aqueous basecoat) produced from a commercial black (or white) aqueous basecoat material from BASF Shanghai Coatings Co. Ltd. The black basecoat and white basecoat were chosen as these two basecoats are basic and mostly available. The results are shown in Table 4.

TABLE 4
Results

| | Examples | | | | | | | | Comparative Examples | | | | |
|---|---|---|---|---|---|---|---|---|---|---|---|---|---|
| Results | 1 | 2 | 3 | 4 | 5 | 6 | 7 | 8 | 1 | 2 | 3 | 4 | 5 |
| Solid content of | 59.2 | 58.87 | 57.6 | 54.7 | 58.4 | 54.3 | 57.5 | 58.2 | 53.4 | 56.3 | 44.7 | 58.2 | 58.2 |
| coating compositions | | | | | | | | | | | | | |
| (wt. %) | | | | | | | | | | | | | |
| Viscosity (s) | 30.6 | 29.8 | 31.2 | 32 | 31.3 | 33.2 | 32.4 | 32.3 | 32.1 | 29.5 | 33 | 30.5 | 30.5 |
| measured by Ford | | | | | | | | | | | | | |
| Cup 4# @ 23° C. of | | | | | | | | | | | | | |
| coating compositions | | | | | | | | | | | | | |

Performance of coating films on black basecoat

| | | | | | | | | | | | | | |
|---|---|---|---|---|---|---|---|---|---|---|---|---|---|
| Tukon Hardness | 12.3 | 13.4 | 12.8 | 13.0 | 13.2 | 12.8 | 13.0 | 12.8 | 13.1 | 7 | 9 | 12.1 | 9 |
| Gloss | 92.3 | 92.3 | 92.2 | 92.1 | 93.0 | 92.3 | 92.6 | 92.5 | 45.5 | 90.3 | 93.0 | 87.6 | 86.1 |
| Lw | 1.3 | 1.3 | 1.2 | 1.9 | 1.5 | 1.6 | 1.6 | 1.8 | 11.3 | / | / | 2.2 | / |
| Sw | 3.1 | 3.2 | 5.1 | 5.2 | 5.6 | 5.9 | 6.7 | 7.5 | 6.2 | / | / | 4.3 | / |
| DOI | 96.3 | 96.3 | 96.0 | 96.0 | 95.9 | 95.9 | 95.8 | 95.8 | 65.0 | / | / | 96.1 | / |

Performance of coating films on white basecoat

| | | | | | | | | | | | | | |
|---|---|---|---|---|---|---|---|---|---|---|---|---|---|
| Tukon Hardness | 12.1 | 13.0 | 12.2 | 12.5 | 13.3 | 12.6 | 12.6 | 12.4 | 13.2 | 7 | 9 | 12 | 9 |
| Gloss | 95.0 | 95.2 | 94.8 | 94.8 | 96.0 | 95.1 | 95.7 | 95.4 | 49.8 | 93.1 | 94.9 | 91.5 | 89.9 |
| Lw | 1.2 | 1.4 | 2.1 | 2.8 | 2.3 | 3.4 | 2.2 | 3.0 | 8.7 | / | / | 3.2 | / |
| Sw | 7.3 | 7.2 | 5.3 | 7.7 | 9.2 | 9.9 | 7.2 | 8.2 | 6.3 | / | / | 6.0 | / |
| DOI | 90.9 | 90.8 | 90.6 | 90.2 | 89.5 | 89.7 | 90.0 | 90.0 | 64.2 | / | / | 89.6 | / |

Notes:
The lower Lw represents better appearance, “/” represents no measurement.

It can be seen from Table 4 that the invented examples show high solid content (i.e. low VOC) and low viscosity simultaneously, and the obtained clearcoat layers exhibit high initial gloss, good appearance as well as sufficient hardness, while the comparative examples show one or more drawbacks.

It will be apparent to one person skilled in the art that various modifications and variations can be made in the present invention without departing from the scope or spirit of the present invention. It is intended that the embodiments and examples be considered as exemplary only. Thus, it is intended that the present invention covers such modifications and variations as come within the scope of the appended claims and their equivalents.

1. A 2K clearcoat coating composition comprising
Component I comprising
(A) a first resin having at least one primary hydroxyl group selected from the group consisting of hydroxyl alkyl (meth)acrylate resins having C₁-C₁₀ alkyl groups,
(B) a second resin having at least one secondary hydroxyl group selected from the group consisting of hydroxyl alkyl (meth)acrylate resins having C₂-C₁₀ alkyl groups, and
(C) at least one amino resin, and
Component II comprising
(D) a crosslinker comprising at least one polyisocyanate,
wherein the first resin has a hydroxyl value in a range of from 100 to 250 mgKOH/g and a weight average molecular weight in a range of from 3,000 to 15,000, and the second resin has a hydroxyl value in a range of from 150 to 500 mgKOH/g and a weight average molecular weight in a range of from 500 to 2,500.

2. The coating composition according to claim 1, wherein said first resin has a Tg in a range of from 10° C. to 80° C.

3. The coating composition according to claim 1, wherein said first resin has an acid value in a range of from 0 to 20.

4. The coating composition according to claim 1, wherein said first resin has a weight average molecular weight in a range of from 3,500 to 12,000.

5. The coating composition according to claim 1, wherein said first resin has a hydroxyl value in a range of from 190 to 250 mgKOH/g and a weight average molecular weight in a range of from 3,000 to 10,000.

6. The coating composition according to claim 1, wherein said first resin has a hydroxyl value in a range of from 100 to 190 mgKOH/g and a weight average molecular weight in a range of from 3,000 to 15,000.

7. The coating composition according to claim 1, wherein said second resin has a hydroxyl value in a range of from 200 to 300 mgKOH/g.

8. The coating composition according to claim 1, wherein said second resin further comprises at least one primary hydroxyl group.

9. The coating composition according to claim 8, wherein the ratio by mole of the secondary hydroxyl group to the primary hydroxyl group in the second resin is in a range of from 2:1 to 10:1.

10. The coating composition according to claim 1, wherein the ratio by mole between NCO groups in Component (D) and the total hydroxyl groups in Components (A) and (B) is in a range of from 0.7:1 to 1.6:1.

11. The coating composition according to claim 1, wherein the weight percentage of Component (A) is in a range of from 15% to 75%, and the percentage of Component (B) is in a range of from 2% to 25%, and the total weight percentage of Component (A) and (B)_is in a range of from 40% to 80%, based on the total weight of the coating composition.

12. The coating composition according to claim 1, wherein the weight percentage of said amino resin is in a range of from 1% to 30%, based on the total weight of the coating composition.

13. The coating composition according to claim 1, wherein said amino resin is melamine resin.

14. An article coated by the coating composition according to claim 1.

15. The coating composition according to claim 1, wherein Component I comprises:
(A) a first resin having at least one primary hydroxyl group selected from the group consisting of hydroxyl alkyl (meth)acrylate resins having C₂-C₆, alkyl groups,
(B) a second resin having at least one secondary hydroxyl group selected from the group consisting of hydroxyl alkyl (meth)acrylate resins having C₂-C₆ alkyl groups, and
(C) at least one amino resin.

16. The coating composition according to claim 1, wherein said first resin has a Tg in a range of from 10° C. to 45° C.

17. The coating composition according to claim 1, wherein said first resin has an acid value in a range of from 2 to 20.

18. The coating composition according to claim 8, wherein the ratio by mole of the secondary hydroxyl group to the primary hydroxyl group in the second resin is in a range of from 3:1 to 5:1.

19. The coating composition according to claim 1, wherein the ratio by mole between NCO groups in Component (D) and the total hydroxyl groups in Components (A) and (B) is in a range of from 1.1:1 to 1.3:1.

20. The coating composition according to claim 1, wherein the weight percentage of Component (A) is in a range of from 25% to 60% and the percentage of Component (B) is in a range of from 5% to 15% and the total weight percentage of Component (A) and (B) is in a range of from 44% to 60%, based on the total weight of the coating composition.
